(19) United States
(12) Patent Application Publication
(10) Pub. No.: US 2026/0299863 A1
(43) Pub. Date: Oct. 1, 2026

(54) DETERMINING RELATIVE POSITIONS OF DEVICES BASED ON USER INPUT

(71) Applicant: Lenovo (Beijing) Limited, Beijing (CN)

(72) Inventors: Amit Kumar Agrawal, Bangalore (IN); Pedro Tadahiro Furtado Kaneko, Campinas (BR); Zhuang Haibin, Fujian Province (CN)

(73) Assignee: Lenovo (Beijing) Limited, Beijing (CN)

(21) Appl. No.: 19/372,819

(22) Filed: Oct. 29, 2025

Related U.S. Application Data
(63) Continuation of application No. PCT/CN2025/085803, filed on Mar. 28, 2025.

(51) Int. Cl. G06F 3/14; G06F 3/0486

(52) U.S. Cl. CPC G06F 3/1423; G06F 3/0486

(57) ABSTRACT

Determining relative positions of devices based on user input. A first electronic device detects that the first electronic device is connected to a second electronic device, and receives user input that indicates multiple attempts to move a user interface (UI) element from a display of the first electronic device to a display of the second electronic device. The first electronic device determines, based at least in part on detecting that the first electronic device is connected to the second electronic device and the multiple attempts to move the UI element from the display of the first electronic device to the display of the second electronic device, a position of the second electronic device relative to the first electronic device, and outputs the position of the second electronic device relative to the first electronic device.

### RELATED APPLICATION

This application claims priority benefit of Application Number PCT/CN2025/085803 filed 28 Mar. 2025 entitled “Determining Relative Positions of Devices based on User Input,” the disclosure of which is incorporated by reference herein in its entirety.

### BACKGROUND

As technology has advanced, our uses for electronic devices have expanded. One such use is small mobile devices, such as smartphones, which have become increasingly powerful despite their small size. These mobile devices provide a great deal of portable processing power but are not without their problems. One such problem is that situations arise in which users desire to use their mobile devices alongside other electronic devices, such as a laptop computer. This can result in the user having to interact with the two devices separately, which can be frustrating for users and lead to user frustration with their devices.

### BRIEF DESCRIPTION OF THE DRAWINGS

Embodiments of determining relative positions of devices based on user inputare described with reference to the following drawings. The same numbers are used throughout the drawings to reference like features and components:

FIGS. 1 and 2 illustrate example systems implementing the techniques discussed herein;

FIGS. 3 through 9 illustrate examples of using the techniques discussed herein;

FIGS. 10 through 12 illustrate examples of electronic devices connected to one another in accordance with one or more implementations;

FIG. 13 illustrates an example process for implementing the techniques discussed herein in accordance with one or more implementations;

FIG. 14 illustrates various components of an example electronic device in which implementations of the techniques discussed herein can be implemented.

### DETAILED DESCRIPTION

Determining relative positions of devices based on user inputis discussed herein. Generally, an electronic device, also referred to as a primary or main electronic device, can be connected to another electronic device, also referred to as a secondary electronic device, allowing the electronic devices to be used together. This connection can be a wired connection or a wireless connection. The primary or main electronic device has a display, also referred to as the primary or main display. Similarly, the secondary device has a display, also referred to as the secondary display.

When the two electronic devices are connected, a single input control device (e.g., a trackpad on a laptop or a mouse) can be used to control user input for both devices. Using a single input control device to control user input for both devices is also referred to as universal control. For example, a trackpad of the main electronic device (or a mouse wirelessly connected to the main electronic device) can be used to move a cursor or drag user interface (UI) elements (e.g., windows, icons) from the display of one of the electronic devices to the display of the other of the electronic devices.

When the two electronic devices are connected to one another, the main electronic device selects (e.g., assumes, such as via a default setting) a location of the secondary electronic device relative to the main electronic device. For example, the main device may have a default configuration that the secondary electronic device is physically located to the left of the main electronic device. However, this default assumption by the electronic device may be inaccurate.

Using the techniques discussed herein the relative location of the secondary electronic device relative to the primary electronic device is automatically determined by detecting one or more user input attempts to move a UI element from the main display to the secondary display. If the user input includes one or more attempts (e.g., multiple attempts repeatedly with a threshold amount of time, such as 5 seconds) to drag or move a UI element from the main display to the secondary display in a particular direction (e.g., left, right, up, or down), then the primary electronic device determines that the secondary electronic device is in that particular direction relative to the primary electronic device. For example, if the primary electronic device assumes by default that the secondary electronic device is to the left of the primary electronic device, and user input attempting to drag an application window or other UI element and repeatedly hits (e.g., gets stopped at) the right edge of the primary display, then the primary electronic device detects that the secondary electronic device is to the right of the primary electronic device. The primary electronic device reconfigures itself based on this detection, allowing the user to drag and drop application windows or other UI elements to the secondary electronic device in the appropriate direction. For example, if the secondary electronic device is to the right of the primary electronic device, then user input dragging a UI element off the right edge of the first display causes the UI element to be displayed on the secondary display.

By detecting the location of the secondary electronic device relative to the primary electronic device, the techniques discussed herein improve the user interface of the one or more electronic devices by automatically reconfiguring (or prompting the user for user input regarding whether to reconfigure) to the primary electronic device for the proper location of the secondary electronic device relative to the primary electronic device. This improves the user interface of the primary electronic device, e.g., by reducing or eliminating the number of menus or screens the user needs to progress through in order to configure the primary electronic device with the location of the secondary electronic device. Furthermore, the techniques discussed herein are based on detecting user input attempting to move a UI element off the display of the primary electronic device. No additional hardware, such as ultrasound sensors or ultra-wideband (UWB) need be used to detect the location of the secondary electronic device relative to the primary electronic device.

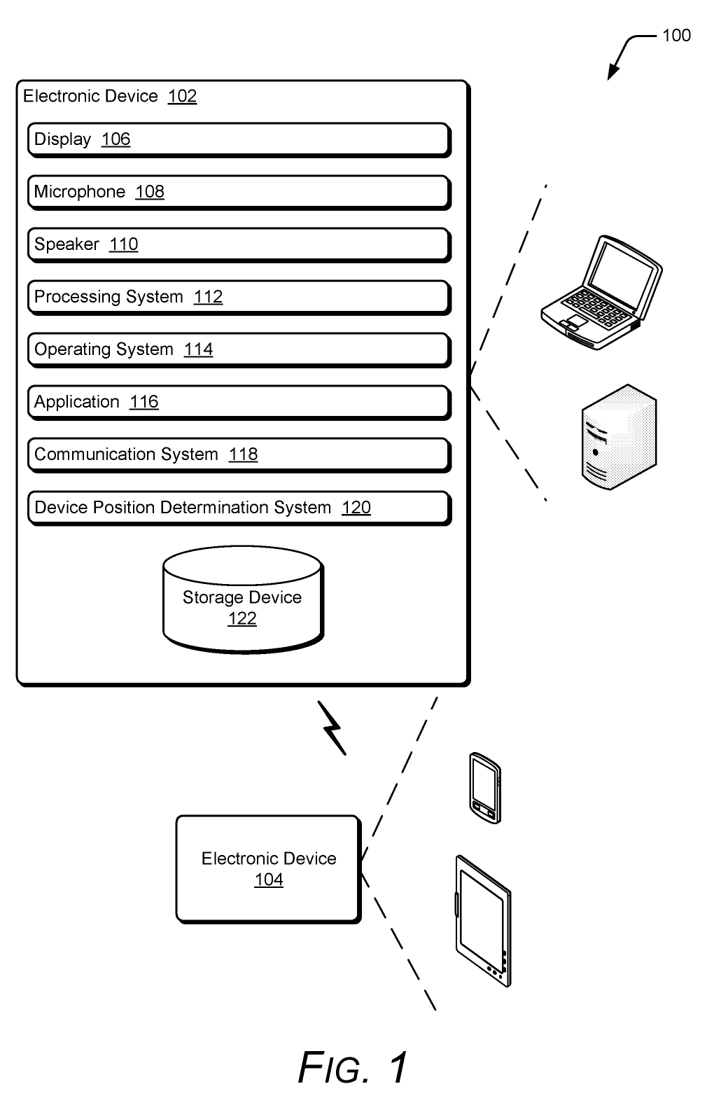

FIG. 1 illustrates an example system 100 implementing the techniques discussed herein. The system 100 includes an electronic device 102 that can be, or include, many different types of computing or electronic devices. For example, the electronic device 102 can be a computing device, such as a smartphone or other wireless phone, a tablet, a desktop computer, a laptop computer, and so forth. The system 100 also includes an electronic device 104, which can also be many different types of computing or electronic devices, but is typically (although need not be) a different type of electronic device than the electronic device 102. For example, the electronic device 104 can be a laptop computer, a desktop computer, an automotive computer, a tablet, and so forth.

In one or more implementations, one or both of the electronic device 102 or the electronic device 104 is a touch-enabled device. A touch-enabled device refers to a device that receives touch inputs via the display (e.g., a touchscreen). A touch-enabled device may also receive inputs via other input mechanisms, such as trackpad, mouse, physical keyboard, and so forth. In other implementations, one or both of the electronic device 102 or the electronic device 104 is a non-touch-enabled device. A non-touch-enabled device refers to a device that does not receive touch inputs via the display (e.g., a touchscreen). Accordingly, a non-touch-enabled device receives inputs via other input mechanisms, such as trackpad, mouse, physical keyboard, and so forth.

The electronic device 102 includes a display 106. The display 106 can be configured as any suitable type of display, such as an organic light-emitting diode (OLED) display, active matrix OLED display, liquid crystal display (LCD), in-plane shifting LCD, projector, and so forth.

The electronic device 102 can also include a microphone 108 and a speaker 110. The microphone 108 can be configured as any suitable type of microphone incorporating a transducer that converts sound into an electrical signal, such as a dynamic microphone, a condenser microphone, a piezoelectric microphone, and so forth. The speaker 110 can be configured as any suitable type of speaker incorporating a transducer that converts an electrical signal into sound, such as a dynamic loudspeaker using a diaphragm, a piezoelectric speaker, non-diaphragm based speakers, and so forth.

Although illustrated as part of the electronic device 102, it should be noted that one or more of the microphone 108 and the speaker 110 can be implemented separately from the electronic device 102. In such situations, the electronic device 102 can communicate with the microphone 108 or the speaker 110 via any of a variety of wired (e.g., Universal Serial Bus (USB), USB-C, IEEE 1394, or wireless (e.g., Wi-Fi, Bluetooth, infrared (IR)) connections. For example, the microphone 108 may be separate from the electronic device 102 and voice inputs received by the microphone 108 are communicated to the electronic device 102 via an IR or radio frequency wireless connection.

The electronic device 102 also includes a processing system 112 that includes one or more processors, each of which can include one or more cores. The processing system 112 is coupled with, and may implement functionalities of, any other components or modules of the electronic device 102 that are described herein. In one or more embodiments, the processing system 112 includes a single processor having a single core. Alternatively, the processing system 112 includes a single processor having multiple cores or multiple processors (each having one or more cores).

The electronic device 102 also includes an operating system 114. The operating system 114 manages hardware, software, and firmware resources in the electronic device 102. The operating system 114 manages one or more applications 116 running on the electronic device 102 and operates as an interface between applications 116 and hardware components of the electronic device 102.

The electronic device 102 also includes a communication system 118. The communication system 118 manages communication with electronic device 104 and optionally various other devices. The electronic device 102 can be connected to the electronic device 104 and communicate with the electronic device 104 using any of a variety of wired or wireless connections, such as USB, USB-C, WiFi^{TM}, WiFi^{TM} IP (Internet Protocol), USB IP, Bluetooth^{TM}, DisplayPort, High-Definition Multimedia Interface (HDMI), and so forth. Typically, the electronic device 102 is removably connected to the electronic device 104, allowing the electronic device 104 to be connected to the electronic device 104 and subsequently disconnected from the electronic device 104.

The electronic device 102 also includes a device position determination system 120 that automatically determines a position of the electronic device 104 relative to the electronic device 102. This position is a physical position, such as the electronic device 104 being to the left of the electronic device 102, to the right of the electronic device 102, above the electronic device 102, below the electronic device 102, and so forth.

The device position determination system 120 can be implemented in a variety of different manners. For example, the device position determination system 120 can be implemented as multiple instructions stored on computer-readable storage media and that can be executed by the processing system 112. Additionally or alternatively, the device position determination system 120 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth).

The electronic device 102 also includes a storage device 122. The storage device 122 can be implemented using any of a variety of storage technologies, such as magnetic disk, optical disc, Flash, or other solid state memory, and so forth. The storage device 122 can store various program instructions and data for any one or more of the operating system 114, application 116, and the device position determination system 120.

In one or more implementations, the electronic device 104 includes components analogous to those discussed above with reference to the electronic device 102, such as a display, a microphone, a speaker, a processing system, an operating system, an application, a communication system, and a storage device. However, the electronic device 104 may not include a system analogous to device position determination system 120.

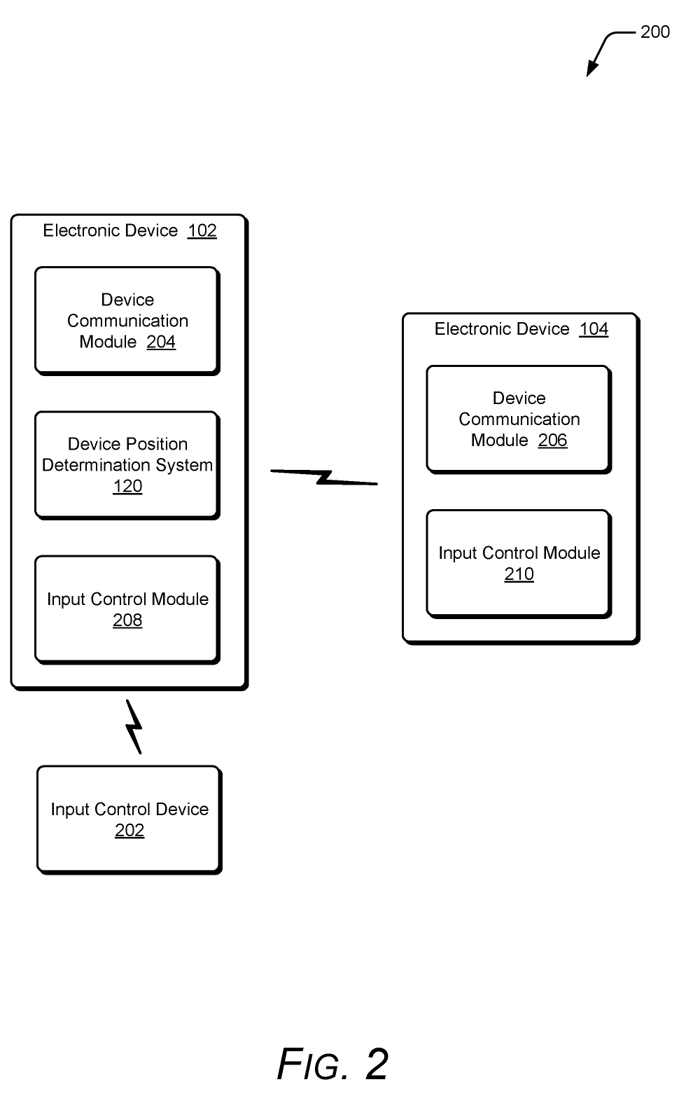

FIG. 2 illustrates an example system 200 implementing the techniques discussed herein. The system 200 includes the electronic device 102, the electronic device 104, and an input control device 202. The input control device 202, which may also be referred to as a cursor control device or a pointer control device, can be implemented in any of a variety of manners. For example, the input control device 202 may be a mouse, trackpad, keyboard, a microphone (e.g., to receive verbal inputs directing selection or movement of a UI element), and so forth. Although illustrated as separate from the electronic device 102, in one or more implementations the input control device 202 is part of the electronic device 102 (e.g., a trackpad of a laptop device).

The electronic device 102 includes a device communication module 204 that implements functionality to detect when the electronic device 102 is connected to the electronic device 104 and to communicate with the electronic device 104 (e.g., send and receive various signals, data, and so forth). Similarly, the electronic device 104 includes a device communication module 206 that implements functionality to detect when the electronic device 104 is connected to the electronic device 102 and to communicate with the electronic device 102 (e.g., send and receive various signals, data, and so forth).

The device communication module 204 can detect that the electronic device 102 is connected to the electronic device 104 (and similarly the device communication module 206 can detect that the electronic device 104 is connected to the electronic device 102) using any of a variety of public or proprietary techniques. For example, the device communication module 206 can transmit a signal that is received by the device communication module 204 indicating to the electronic device 102 that the electronic device 104 is connected to the electronic device 102. Similarly, the device communication module 204 can transmit a signal that is received by the device communication module 206 indicating to the electronic device 104 that the electronic device 102 is connected to the electronic device 104.

In one or more implementations, the device position determination system 120 determines the position of the electronic device 104 relative to the electronic device 102 and provides the relative position to the input control module 208. The input control module 208 determines whether to transmit indications of user inputs to the electronic device 102, e.g., from the input control device 202, as discussed in more detail below.

The device position determination system 120 determines the position of the electronic device 104 relative to the electronic device 102 in response to the device communication module 204 determining that the electronic device 102 and the electronic device 104 are connected to one another. The device position determination system 120 also optionally determines the position of the electronic device 104 relative to the electronic device 102 in response to other events, conditions, or configurations. For example, in one or more implementations, the device position determination system 120 also determines or checks whether a universal control mode has been activated or turned on. When activated or turned on, the universal control mode indicates that inputs received by the electronic device 102 (e.g., from the input control device 202) can be used to control the electronic device 104. The device position determination system 120 determines a position of the electronic device 104 relative to the electronic device 102 in response to the universal control mode being activated and the electronic device 102 being connected to the electronic device 104.

The device position determination system 120 can determine whether the universal control mode is activated or deactivated in any of a variety of different manners. In one or more implementations, a user input is received indicating whether the universal control mode is activated or deactivated and an indication whether the universal control mode is activated or deactivated is saved as a configuration setting. Additionally or alternatively, the operating system 114 or an application 116 may specify whether the universal control mode is activated or deactivated.

In one or more implementations, the input control module 208 has an initial setting (e.g., a default configuration or setting) of the position of the electronic device 104 relative to the electronic device 102. For example, the default setting may be that when an electronic device 104 is connected to the electronic device 102, the electronic device 104 is positioned to the left of the electronic device 102. The input control module 208 uses the position indicated by the initial setting to determine whether to provide an indication of user input to the electronic device 104 as discussed in more detail below. The device position determination system 120 can subsequently automatically determine the position of the electronic device 104 relative to the electronic device 102 as discussed in more detail below, which can override or replace the initial setting of the position of the electronic device relative to the electronic device 102. Accordingly, in such situations the input control module 208 uses the position indicated by the device position determination system 120 to determine whether to provide an indication of user input to the electronic device 104 as discussed in more detail below.

The device position determination system 120 automatically determines the position of the electronic device 104 relative to the electronic device 102 in response to receiving user input that indicates multiple attempts (where at least one of the multiple attempts is unsuccessful) by the user to move a UI element (e.g., a cursor or pointer, a window, an icon, menu, button) from the display of the electronic device 102 to the display of the electronic device 104. If the user input indicates multiple attempts (at least one of which is unsuccessful) by the user to move one or more UI elements from the display of the electronic device 102 to the display of the electronic device 104, the device position determination system 120 determines that the electronic device 104 is positioned in the direction of the unsuccessful attempt. For example, if the user input indicates multiple attempts (at least one of which is unsuccessful) by the user to drag or move a UI element off the display of the electronic device 102 in a particular direction (e.g., left, right, up, or down), then the device position determination system 120 determines that the electronic device 104 is positioned in that particular direction relative to the primary electronic device. E.g., if the user input indicates multiple attempts (at least one of which is unsuccessful) by the user to drag or move a UI element off the right side of the display of the electronic device 102, then the device position determination system 120 determines that the electronic device 104 is positioned to the right of the electronic device 102.

The device position determination system 120 determines or identifies an unsuccessful attempt by the user to move one or more UI elements from the display of the electronic device 102 to the display of the electronic device 104 in any of a variety of different manners. In one or more implementations, if a user attempts to drag or move a UI element and is stopped at one of the edges of the screen of the electronic device 102 (e.g., the user attempts to drag or move the UI element off the screen), then the device position determination system 120 determines or identifies that user input as an unsuccessful attempt by the user to move one or more UI elements from the display of the electronic device 102 to the display of the electronic device 104.

A user attempt to drag or move a UI element is stopped (e.g., allowed to go no further in the direction indicated by the user input) based on one or more conditions or events. In one or more implementations, an application or program (e.g., the operating system 114 or the input control module 208) determines the location of the UI element is at the edge of the screen and cannot be moved further (e.g., because a determination has not been made yet that the electronic device 104 is positioned relative to the electronic device 102 in the direction of movement or dragging of the UI element). For example, the default setting may be that when an electronic device 104 is connected to the electronic device 102, the electronic device 104 is positioned to the left of the electronic device 102. Accordingly, until over-ridden or replaced by the device position determination system 120, the application or program stops the dragging or moving of the UI element beyond the right edge of the display of the electronic device 102. The location of the element can be determined in various manners, such as the location of the entire UI element (e.g., all of a pointer or all of a window) or a location of a portion of the UI element (e.g., the tip of a pointer, approximately half of a window), and so forth.

In one or more implementations, if the user attempts to drag or move the UI element off the side of the display of the electronic device 102 at least a threshold number of times (also referred to as a threshold number of attempts) within a threshold amount of time, then in response to the current (or next) attempt to drag or move the UI element off the screen in the same direction the device position determination system 120 determines that the electronic device 104 is positioned in the direction of that side relative to the electronic device 102. Accordingly, the current (or next) attempt is successful. In one or more implementations, the threshold number of times is selected so as to avoid the situation where the device position determination system 120 determines the position of the electronic device 104 relative to the electronic device 102 in response to a single user attempt to drag or move a UI element that is stopped at one of the edges of the screen. Thus, the user accidentally moving or dragging a UI element just once that is stopped at the edge of the screen of the electronic device 102 does not trigger the device position determination system 120 determining the position of the electronic device 104 relative to the electronic device 102. In one or more implementations, the threshold amount of time is selected so as to avoid the situation where the device position determination system 120 determines the position of the electronic device 104 relative to the electronic device 102 in response to multiple attempts to drag or move a UI element that is stopped at one of the edges of the screen separated by a large distance in time (e.g., more than 30 seconds). Thus, the user accidentally moving or dragging a UI element multiple times that are each stopped at the edge of the screen of the electronic device 102 but far apart (e.g., more than 30 seconds or 1 minute) does not trigger the device position determination system 120 determining the position of the electronic device 104 relative to the electronic device 102.

In one or more implementations, the threshold number of times is 2 and the threshold amount of time is 5 seconds. Additionally, or alternatively, other threshold values can be used. In one or more implementations, these threshold values can be selected by the user (e.g., the device position determination system 120 receives user inputs identifying one or both of the threshold number of times and the threshold amount of time).

In one or more implementations, when the threshold number of times is 2 or more times, the multiple attempts are consecutive attempts to drag or move a UI element from the display of the electronic device 102 to the display of the electronic device 104 in the same direction (e.g., across the same edge of the display of the electronic device 102). For example, if the user attempted to drag or move a UI element to the right of the display of the electronic device 102, then quickly attempted to drag or move a UI element to the left of the display of the electronic device 102, then quickly attempted to drag or move a UI element to the right of the display of the electronic device 102, the two attempts to drag or move the UI element to the right edge of the display of the electronic device 102 are not consecutive due to the attempt to drag or move a UI element to the left of the display of the electronic device 102 being in-between the two attempts to drag or move the UI element to the right edge of the display of the electronic device 102. Additionally, or alternatively, the multiple attempts can be non-consecutive attempts to drag or move a UI element that is stopped at the same edge of the screen.

The electronic device 102 receives user input via the input control device 202. This user input can take various forms, such as movement of a cursor or pointer, selection of a button or switch, selection of a pull-down menu, and so forth. The input control module 208 receives this user input and performs whatever action is indicated by the user input, such as moving a pointer or cursor, activating or selecting a button that is clicked on, and so forth, or provides an indication of the user input to an input control module 210 of the electronic device 104. This indication of the user input can include various information, such as a direction of movement of the input control device 202, an amount or length of movement of the input control device 202, user activation of a button (e.g., a mouse click), and so forth. The input control module 210 performs whatever action is indicated by the received indication, such as moving a pointer or cursor, activating or selecting a button that is clicked on, and so forth.

Whether the input control module 208 performs the action indicated by the user input or provides an indication of the user input to the input control module 210 depends on the user input and a current location of a pointer or cursor. The input control module 208 knows the dimensions of a display of the electronic device 102 and keeps track of the current location of the pointer or cursor on the display of the electronic device 102. The input control module 208 also knows the location of the electronic device 104 relative to the electronic device 102 (e.g., whether the electronic device 104 is to the left of the electronic device 102, the electronic device 104 is to the right of the electronic device 102, and so forth).

If user input would result in moving the pointer or cursor off the display on the electronic device 102 in the direction of the electronic device 104 (e.g., as determined by the device position determination system 120), the input control module 208 stops displaying the pointer or cursor (or at least a portion of the pointer or cursor) on the display of the electronic device 102 and also provides the indication of the user input to the input control module 210 so that the input control module 210 can, for example, display and move the pointer or cursor (or at least the portion of the pointer or cursor) appropriately on the display of the electronic device 104, or select the appropriate button on the display of the electronic device 104. Similarly, if the user input then moves the pointer or cursor off the display of the electronic device 104 in the direction of the electronic device 102, the input control module 210 stops displaying the cursor or pointer on the display of the electronic device 104, the input control module 208 stops providing the indication of the user input to the input control module 210, and the input control module 208 displays and moves the pointer or cursor appropriately, or selects the appropriate button, on the display of the electronic device 102.

In one or more implementations, the input control module 208 displays an indication of which side (e.g., left, right, top, or bottom) of the electronic device 102 the electronic device 104 is positioned (e.g., where the electronic device 104 is positioned relative to the electronic device 102). The displayed indication can take various forms, such as a rectangular box along the entire edge of the display of the electronic device 102 with a particular fill or color (e.g., a green box), a rectangular box along a portion of the edge of the display of the electronic device 102 with a particular fill or color (e.g., a green box), changing the manner in which the pointer or cursor is displayed (e.g., changing the color of the pointer or cursor), a graphical representations of the electronic devices 102 and 104 illustrating their positions relative to one another (e.g., a graphical representation of the electronic device 104 to the right of the graphical representation of the electronic device 102), and so forth.

In one or more implementations, the input control module 210 displays an indication of which side (e.g., left, right, top, or bottom) of the electronic device 104 the electronic device 102 is positioned (e.g., where the electronic device 102 is positioned relative to the electronic device 104). The displayed indication can take various forms as discussed with respect to the input control module 208.

It should be noted that in some situations the height or width of the display of the electronic device 102 may be different than the height or width of the display of the electronic device 104. In such situations, various techniques can be used when the user input moves the pointer or cursor from one display to the other. For example, if the height of the display of the electronic device 102 is larger than the height of the display of the electronic device 104 and the cursor is at the top of the display of the electronic device 102, then the pointer or cursor may be moved to the top of the display of the electronic device 104. By way of another example, if the height of the display of the electronic device 102 is larger than the height of the display of the electronic device 104 and the cursor is at the top of the display of the electronic device 102, then the pointer or cursor may not be moved to the display of the electronic device 104 until further user input moves the pointer or cursor down to the height of the top of the display of the electronic device 104.

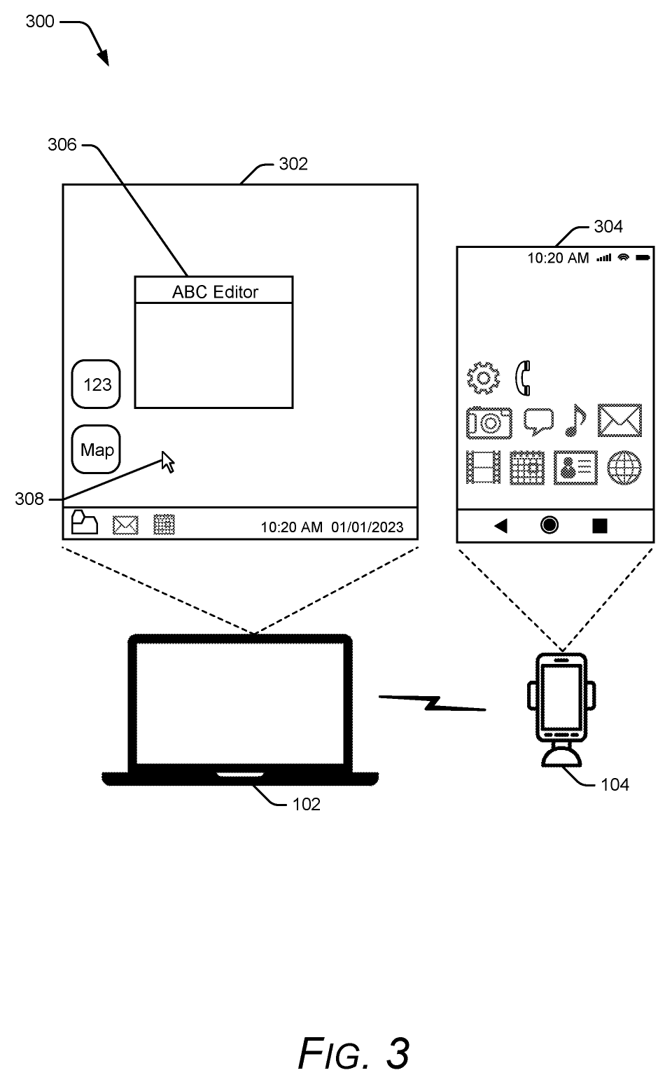

FIGS. 3, 4, 5, 6, 7, 8, and 9 illustrate examples of using the techniques discussed herein. It is to be appreciated that these are only examples and that the electronic devices can be at any location relative to each other (e.g., the electronic device 104 can be positioned to the left of the electronic device 102, positioned above the electronic device 102, positioned below the electronic device 102. Furthermore, specific examples of electronic devices are illustrated, such as a laptop computer, a smartphone, or a tablet. It is to be appreciated that these are only examples and that the electronic devices can be any of a variety of electronic devices as discussed above.

FIG. 3 illustrates an example 300 of using the techniques discussed herein. The example 300 includes the electronic device 102 (illustrated as a laptop computer) and the electronic device 104 (illustrated as a smartphone in a holder or stand). In the example 300, the electronic device 104 is positioned to the right of the electronic device 102. The electronic device 102 displays on its display a user interface 302 including multiple icons that can be selected to perform various operations or run various applications (e.g., an envelope icon selectable to launch an email application, a calendar icon selectable to launch a calendar application), a button “123” selectable to launch a calculator application, a button “map” selectable to launch a map application, and a window 306 of a word processing program. The user interface 302 also displays a current time (e.g., 10:20 AM) and a current date (e.g., 01/01/2023). The user interface user interface 302 also includes a pointer 308 that is controlled by an input control device of the electronic device 102 (e.g., the input control device 202 of FIG. 2, such as a trackpad that is part of the electronic device 102).

The electronic device 104 displays on its display a user interface 304 including multiple icons that can be selected to perform various operations or run various applications (e.g., an envelope icon selectable to launch an email application, a calendar icon selectable to launch a calendar application). The user interface 304 also displays a current time (e.g., 10:20 AM), wireless signal strength, battery level, and so forth.

In the example 300, the user input via the input control device of the electronic device 104 has resulted in the window 306 and the pointer 308 being located on the display of the electronic device 102. Accordingly, no pointer nor window 306 is displayed on the display of the electronic device 104.

As illustrated in the example 300, different user interfaces are displayed by the electronic devices 102 and 104. The user interface 302 displayed on the display of the electronic device 102 is different than the user interface 304 displayed on the electronic device 104 (e.g., the user interface 302 is not mirrored on the display of the electronic device 104), the user interface 302 need not be displayed within a window on the display of the electronic device 104, and so forth.

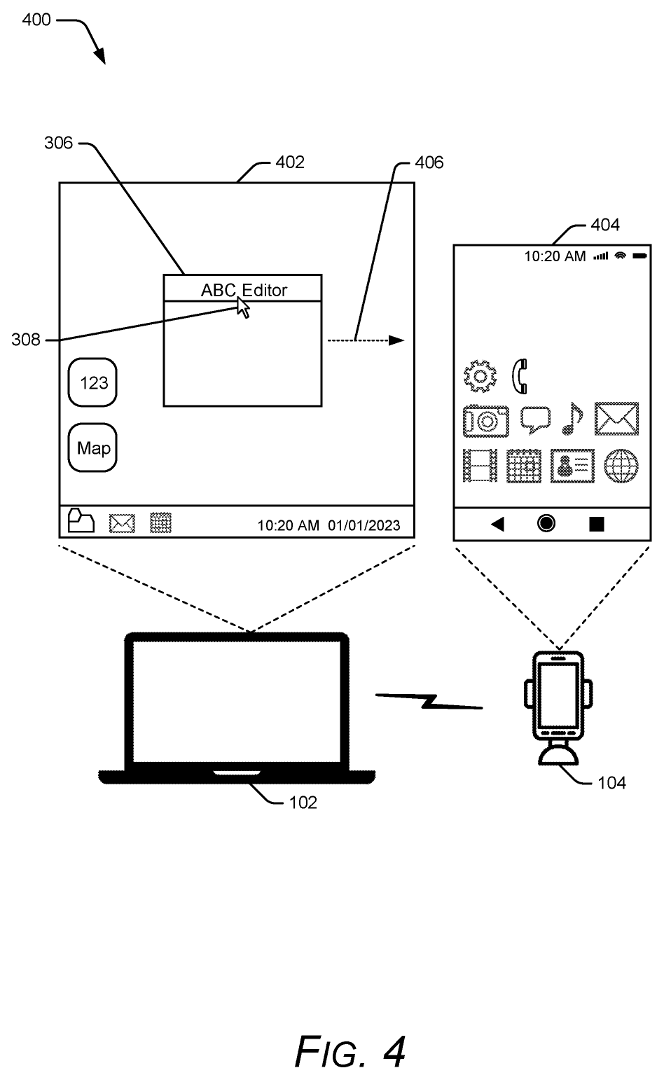

FIG. 4 illustrates an example 400 of using the techniques discussed herein. The example 400 includes the electronic device 102 (illustrated as a laptop computer) displaying the user interface 402 and the electronic device 104 (illustrated as a smartphone in a holder or stand) displaying the user interface 404. In the example 400, the electronic device 104 is positioned to the right of the electronic device 102. The example 400 is analogous to the example 300 of FIG. 3, except that the user input via the input control device of the electronic device 102 has resulted in the pointer 308 being moved over the window 306 and the user attempting to move or drag the window 306 to the right, towards the electronic device 104, as indicated by arrow 406.

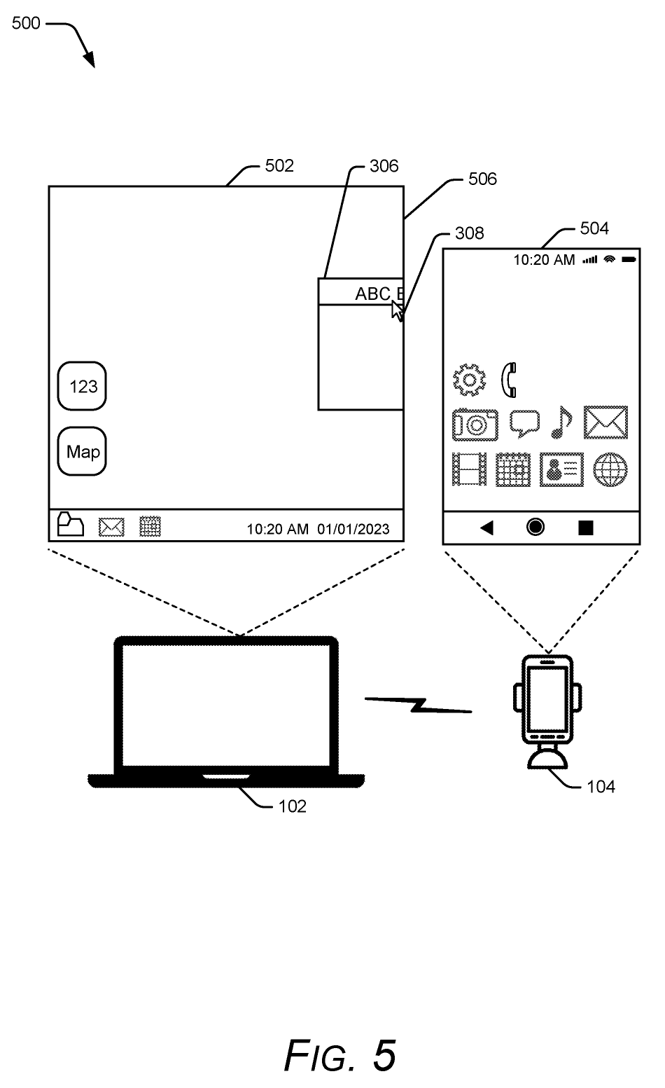

FIG. 5 illustrates an example 500 of using the techniques discussed herein. The example 500 includes the electronic device 102 displaying the user interface 502 and the electronic device 104 displaying the user interface 504. The example 500 is analogous to the example 400 of FIG. 4, except that the attempt of the user to move or drag the window 306 onto the user interface 504 of the electronic device 104 has been stopped at the right edge 506 of the display of the electronic device 102.

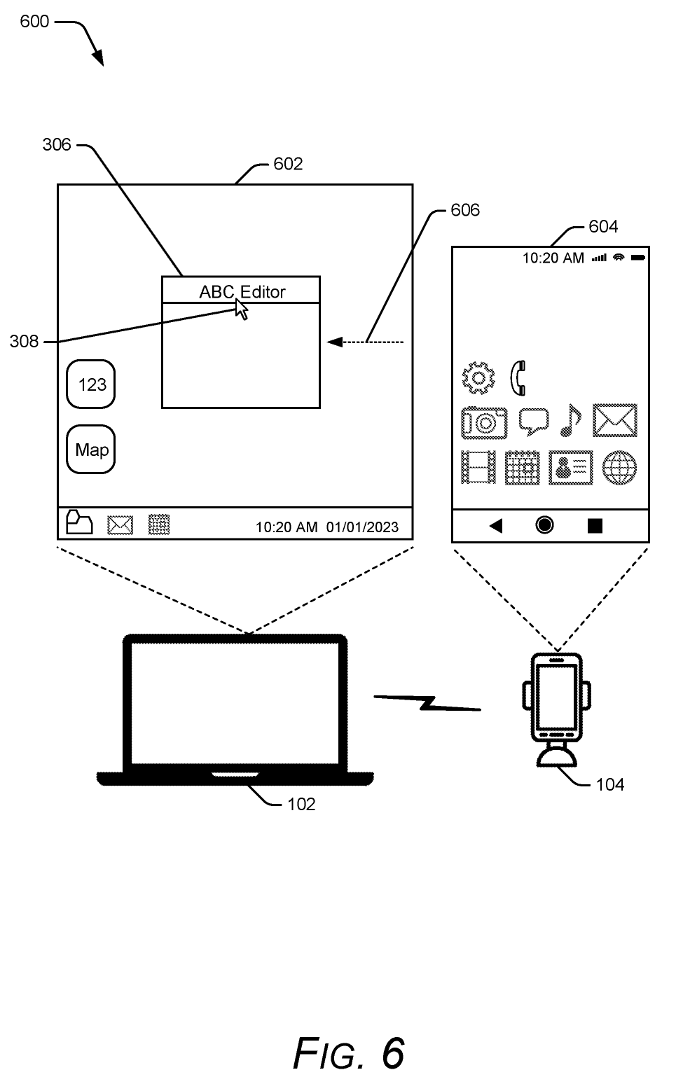

FIG. 6 illustrates an example 600 of using the techniques discussed herein. The example 600 includes the electronic device 102 displaying the user interface 602 and the electronic device 104 displaying the user interface 604. The example 600 is analogous to the example 500 of FIG. 5, except that the user input via the input control device of the electronic device 102 has resulted in the user moving or dragging the window 306 to the left, away from the electronic device 104, as indicated by arrow 606.

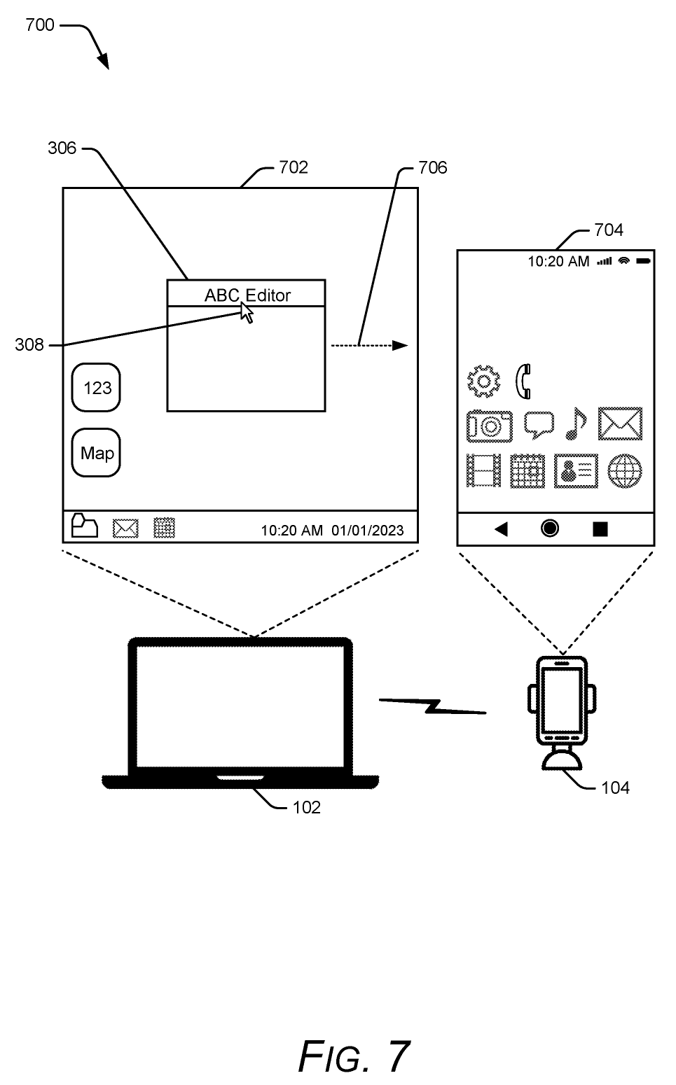

FIG. 7 illustrates an example 700 of using the techniques discussed herein. The example 700 includes the electronic device 102 displaying the user interface 702 and the electronic device 104 displaying the user interface 704. The example 700 is analogous to the example 600 of FIG. 6, except that the user input via the input control device of the electronic device 102 has resulted in the user again attempting to move or drag the window 306 to the right, towards the electronic device 104, as indicated by arrow 706.

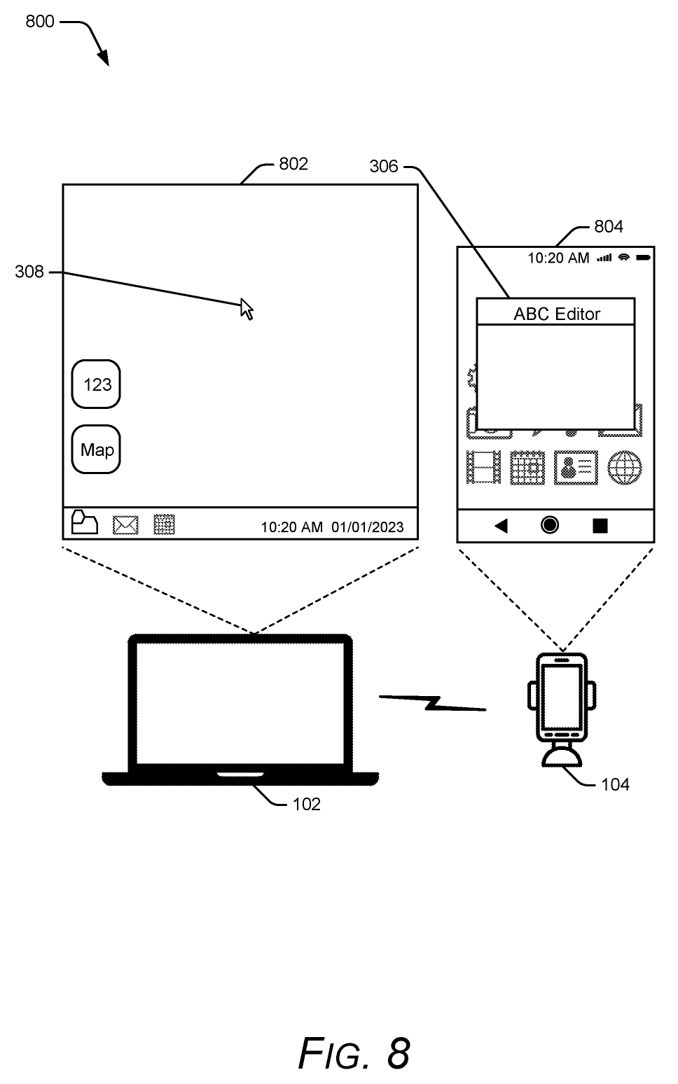

FIG. 8 illustrates an example 800 of using the techniques discussed herein. The example 800 includes the electronic device 102 displaying the user interface 802 and the electronic device 104 displaying the user interface 804. The example 800 is analogous to the example 700 of FIG. 7, except that the device position determination system 120 has determined, after two attempts to move the window 306 to the display of the electronic device 104 (the first of which was unsuccessful), that the electronic device 104 is positioned to the right of the electronic device 102. Accordingly, the user input via the input control device of the electronic device 102 has resulted in the user moving or dragging the window 306 onto the display of the electronic device 104, where the window 306 is displayed as part of the user interface 804. Additionally, the user input via the input control device of the electronic device 102 has resulted in the user moving the pointer 308 back to the display of the electronic device 102, where the pointer 308 is displayed as part of the electronic device 102.

In the example 800, the device position determination system 120 automatically determines the position of the electronic device 104 relative to the electronic device 102 and the input control module 208 automatically uses that position of the electronic device 104 when determining whether to performs the action indicated by the user input or provide an indication of the user input to the input control module 210 of the electronic device 104.

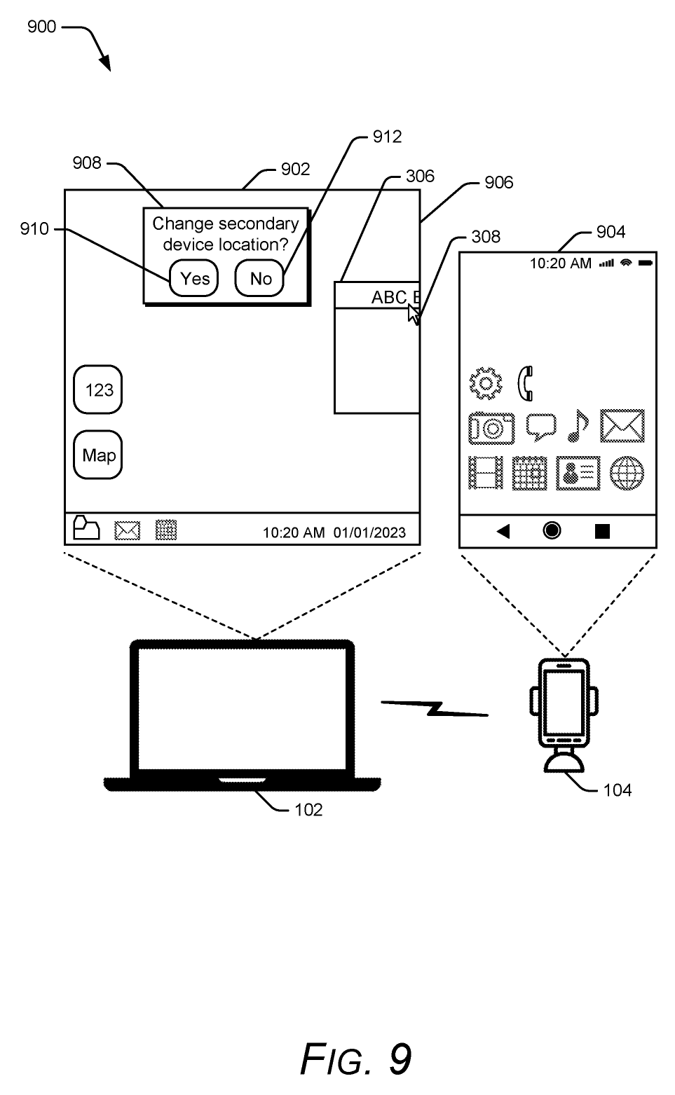

FIG. 9 illustrates an example 900 of using the techniques discussed herein. The example 900 includes the electronic device 102 displaying the user interface 902 and the electronic device 104 displaying the user interface 904. The example 900 is analogous to the example 700 of FIG. 7, except that, analogous to the discussion of FIG. 5 above, the attempt of the user to move or drag the window 306 onto the user interface 904 of the electronic device 104 has been stopped at the right edge 906 of the display of the electronic device 102. The device position determination system 120 displays a prompt 908 querying the user as to whether to change or accept the location or position of the secondary electronic device (the electronic device 104) or the secondary display (the display of the electronic device 104) relative to the electronic device 102. In response to a user input selecting to change the location or position of the secondary electronic device (e.g., selection of the “yes” button 910) via the input control device of the electronic device 102, the device position determination system 120 determines the position of the electronic device 104 to be to the right of the electronic device 102. The user input via the input control device of the electronic device 102 to move or drag the window 306 to the right results in the user moving or dragging the window 306 onto the display of the electronic device 104, where the window 306 is displayed as part of the user interface, as discussed above with respect to FIG. 8.

However, in response to a user input selecting not to change the location or position of the secondary electronic device (e.g., selection of the “no” button 912) via the input control device of the electronic device 102, the position of the electronic device 104 is not changed to be to the right of the electronic device 102. The attempt of the user to move or drag the window 306 onto the user interface 904 of the electronic device 104 is unsuccessful and remains stopped at the right edge 906 of the display of the electronic device 102.

It should be noted that some discussions herein refer to two electronic devices. However, it is to be appreciated that one electronic device may be connected to multiple other devices, such as one to the right and one above. The techniques discussed herein apply to situations where two or more electronic devices are connected to another electronic device (e.g., electronic device 102) and the device position determination system 120 automatically determines the positions of each of those two or more electronic devices relative to the electronic device 102.

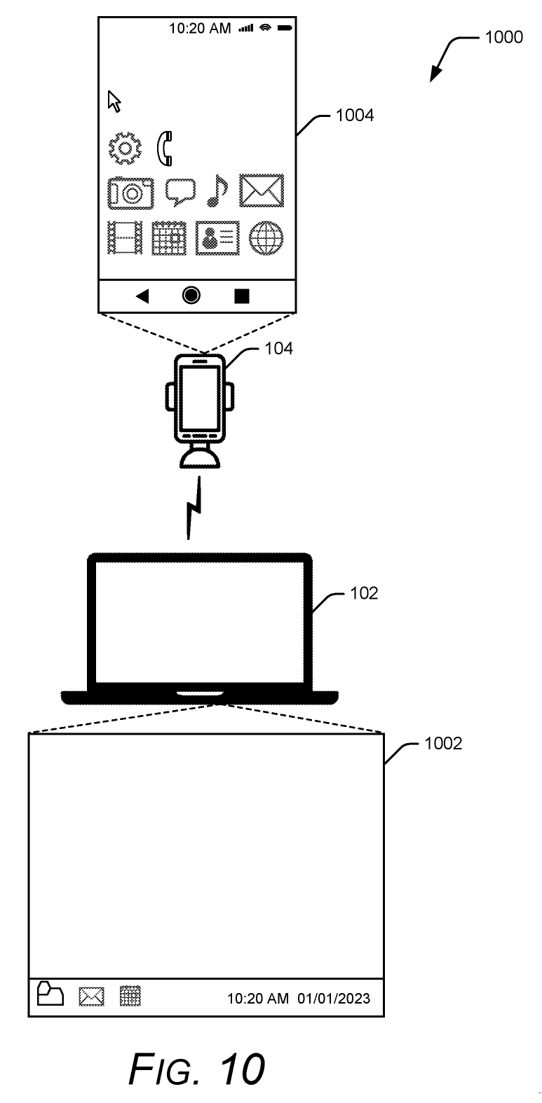

FIG. 10 illustrates an example 1000 of electronic devices connected to one another in accordance with one or more implementations. The example 1000 includes the electronic device 102 displaying the user interface 1002 and the electronic device 104 displaying the user interface 1004. The example 1000 is analogous to the discussions above, except that the electronic device 104 is positioned above the electronic device 102.

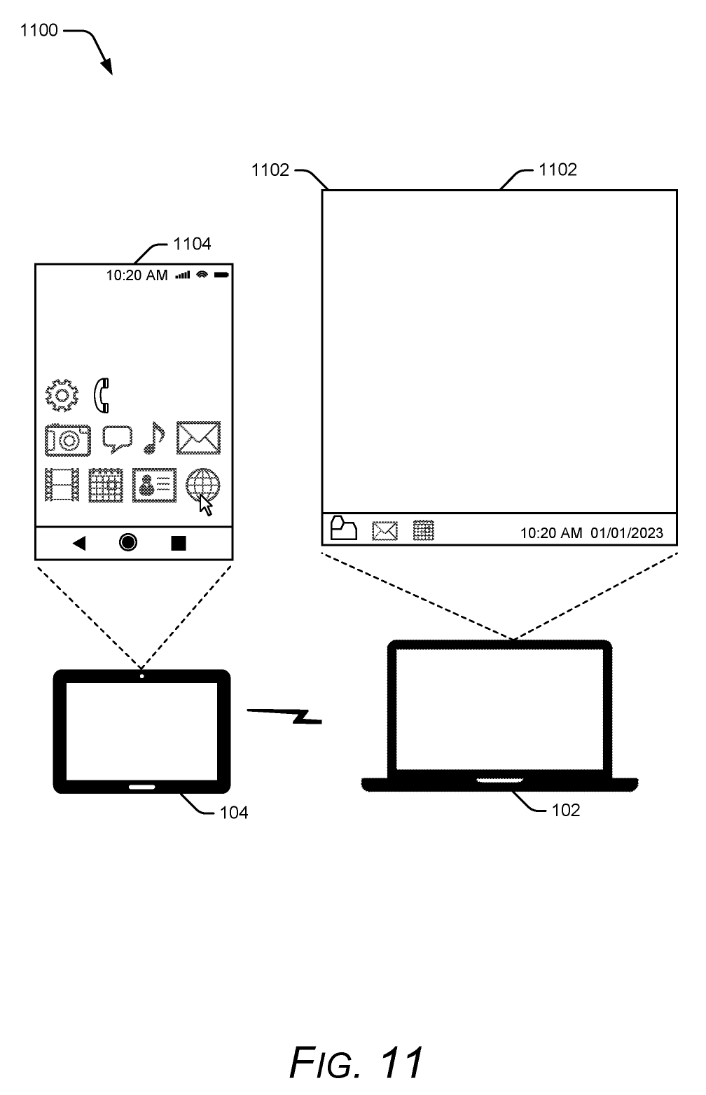

FIG. 11 illustrates an example 1100 of electronic devices connected to one another in accordance with one or more implementations. The example 1100 includes the electronic device 102 displaying the user interface 1102 and the electronic device 104 displaying the user interface 1104. The example 1100 is analogous to the discussions above, except that the electronic device 104 is positioned to the left of the electronic device 102.

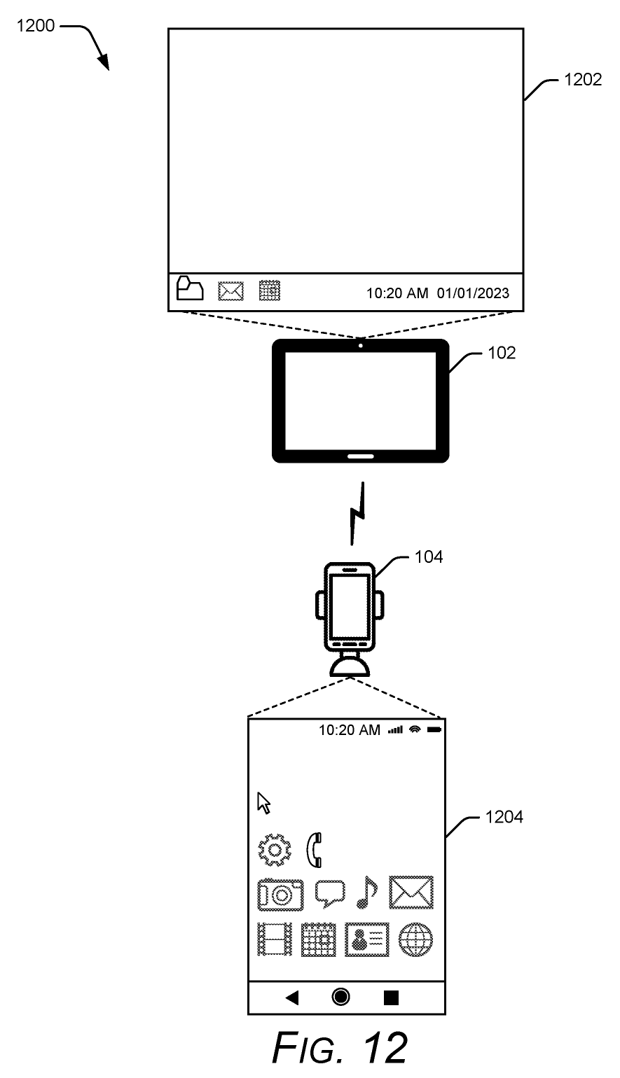

FIG. 12 illustrates an example 1200 of electronic devices connected to one another in accordance with one or more implementations. The example 1200 includes the electronic device 102 displaying the user interface 1202 and the electronic device 104 displaying the user interface 1204. The example 1200 is analogous to the discussions above, except that the electronic device 104 is positioned below the electronic device 102.

It is to be appreciated that these are only examples and that the electronic devices can be at any location relative to each other (e.g., the electronic device 104 can be positioned to the left of the electronic device 102, positioned above the electronic device 102, positioned below the electronic device 102. Furthermore, specific examples of electronic devices are illustrated, such as a laptop computer, a smartphone, or a tablet. It is to be appreciated that these are only examples and that the electronic devices can be any of a variety of electronic devices as discussed above.

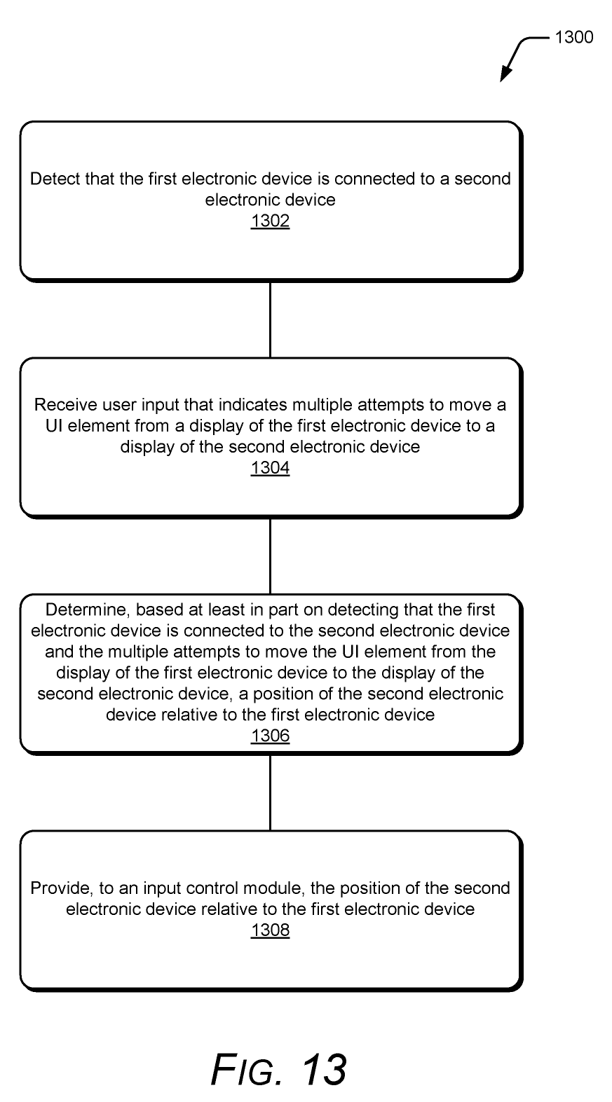

FIG. 13 illustrates an example process 1300 for implementing the techniques discussed herein in accordance with one or more implementations. Process 1300 is carried out at least in part by a device position determination system, such as device position determination system 120 of FIGS. 1 or 2, and can be implemented in software, firmware, hardware, or combinations thereof. Process 1300 is shown as a set of acts and is not limited to the order shown for performing the operations of the various acts.

At 1302 a first electronic device being connected to a second electronic device is detected. As discussed above, this connection can be a wireless connection or a wired connection.

At 1304, user input that indicates multiple attempts to move a UI element from a display of the first electronic device to a display of the second electronic device is received. This user input is received, for example, via an input control device that is part of or coupled (e.g., via a wireless connection or a wired connection) to the first electronic device.

At 1306, a position of the second electronic device relative to the first electronic device is determined. This determination is based at least in part on detecting that the first electronic device is connected to the second electronic device and the multiple attempts to move the UI element from the display of the first electronic device to the display of the second electronic device. This determination can also be based at least in part on determining that a universal control mode for the first electronic device is turned on or activated.

At 1308, the position of the second electronic device relative to the first electronic device is output. The position can be output to or provided to, for example, an input control module.

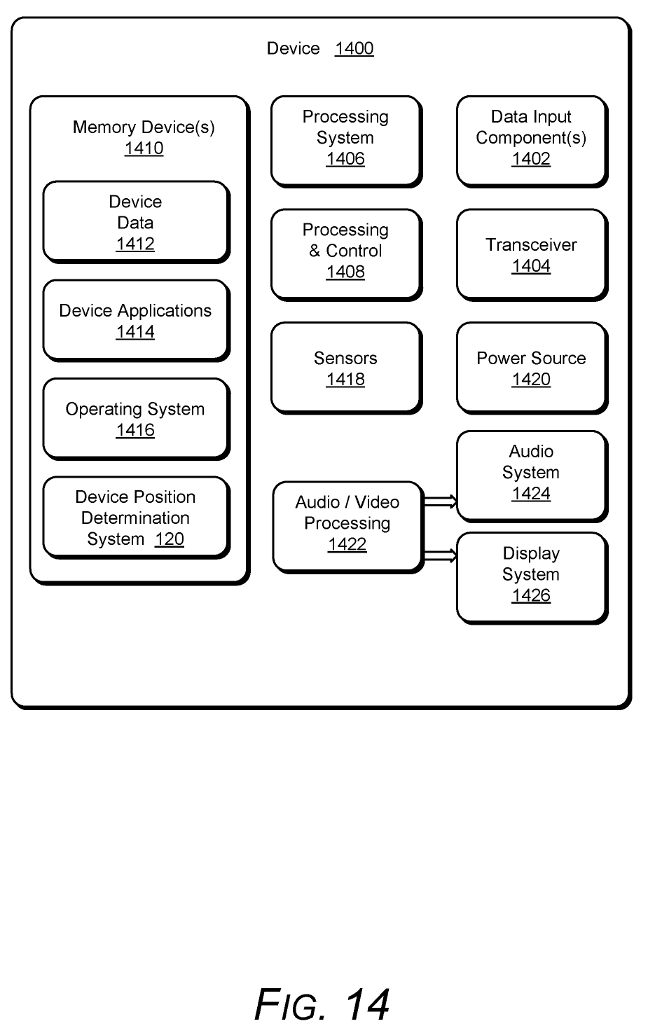

FIG. 14 illustrates various components of an example electronic device in which implementations of the techniques discussed herein can be implemented. The electronic device 1400 can be implemented as any of the devices described with reference to the previous FIGs., such as any type of client device, mobile phone, tablet, computing, communication, entertainment, gaming, media playback, or other type of electronic device. In one or more implementations the electronic device 1400 is an electronic device 102 or electronic device 104 described above. In one or more implementations the electronic device 1400 includes the device position determination system 120 described above.

The electronic device 1400 includes one or more data input components 1402 via which any type of data, media content, or inputs can be received such as user-selectable inputs, messages, music, television content, recorded video content, and any other type of text, audio, video, or image data received from any content or data source. The data input components 1402 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 1402 may also include various other input components such as microphones, touch sensors, touchscreens, keyboards, and so forth.

The device 1400 includes communication transceivers 1404 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth^{TM}) standards, wireless local area network (WLAN) radios compliant with any of the various IEEE 802.11 (WiFi^{TM}) standards, wireless wide area network (WWAN) radios for cellular phone communication, wireless metropolitan area network (WMAN) radios compliant with various IEEE 802.15 (WiMAX^{TM}) standards, wired local area network (LAN) Ethernet transceivers for network data communication, and cellular networks (e.g., third generation networks, fourth generation networks such as LTE networks, or fifth generation networks).

The device 1400 includes a processing system 1406 of one or more processors (e.g., any of microprocessors, controllers, and the like) or a processor and memory system implemented as a system-on-chip (SoC) that processes computer-executable instructions. The processing system 1406 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 1408. The device 1400 may further include any type of a system bus or other data and command transfer system that couples the various components within the device. A system bus can include any one or combination of different bus structures and architectures, as well as control and data lines.

The device 1400 also includes computer-readable storage memory devices 1410 that enable data storage, such as data storage devices that can be accessed by an electronic device, and that provide persistent storage of data and executable instructions (e.g., software applications, programs, functions, and the like stored thereon). Examples of the computer-readable storage memory devices 1410 include volatile memory and non-volatile memory, fixed and removable media devices, and any suitable memory device or electronic data storage that maintains data for electronic device access. The computer-readable storage memory can include various implementations of random access memory (RAM), read-only memory (ROM), flash memory, and other types of storage media in various memory device configurations. The device 1400 may also include a mass storage media device.

The computer-readable storage memory device 1410 provides data storage mechanisms to store the device data 1412, other types of information or data, and various device applications 1414 (e.g., software applications). For example, an operating system 1416 can be maintained as software instructions with a memory device and executed by the processing system 1406 to cause the processing system 1406 to perform various operations or actions. The device applications 1414 may also include a device manager, such as any form of a control application, software application, signal-processing and control module, code that is native to a particular device, a hardware abstraction layer for a particular device, and so on.

The device 1400 can also include one or more device sensors 1418, such as any one or more of an ambient light sensor, a proximity sensor, a touch sensor, an infrared (IR) sensor, accelerometer, gyroscope, thermal sensor, audio sensor (e.g., microphone), and the like. The device 1400 can also include one or more power sources 1420, such as when the device 1400 is implemented as a computing device. The power sources 1420 may include a charging or power system, and can be implemented as a flexible strip battery, a rechargeable battery, a charged super-capacitor, or any other type of active or passive power source.

The device 1400 additionally includes an audio or video processing system 1422 that generates one or both of audio data for an audio system 1424 and display data for a display system 1426. In accordance with some embodiments, the audio/video processing system 1422 is configured to receive call audio data from the transceiver 1404 and communicate the call audio data to the audio system 1424 for playback at the device 1400. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”.

Although embodiments of techniques for determining relative positions of devices based on user inputhave been described in language specific to features or methods, the subject of the appended claims is not necessarily limited to the specific features or methods described. Rather, the specific features and methods are disclosed as example implementations of techniques for implementing determining relative positions of devices based on user input. Further, various different embodiments are described, and it is to be appreciated that each described embodiment can be implemented independently or in connection with one or more other described embodiments. Additional aspects of the techniques, features, and/or methods discussed herein relate to one or more of the following.

In some aspects, the techniques described herein relate to a first electronic device, including: at least one memory; and at least one processor coupled with the at least one memory and configured to cause first electronic device to: detect that the first electronic device is connected to a second electronic device; receive user input that indicates multiple attempts to move a user interface (UI) element from a display of the first electronic device to a display of the second electronic device; determine, based at least in part on detecting that the first electronic device is connected to the second electronic device and the multiple attempts to move the UI element from the display of the first electronic device to the display of the second electronic device, a position of the second electronic device relative to the first electronic device; and provide, to an input control module, the position of the second electronic device relative to the first electronic device.

In some aspects, the techniques described herein relate to a first electronic device, where the multiple attempts include at least one unsuccessful attempt.

In some aspects, the techniques described herein relate to a first electronic device, where the multiple attempts include at least a threshold number of attempts within a threshold amount of time.

In some aspects, the techniques described herein relate to a first electronic device, where the at least one processor is further configured to cause the first electronic device to receive user input indicating at least one of the threshold number of attempts or the threshold amount of time.

In some aspects, the techniques described herein relate to a first electronic device, where the user input indicates movement of the UI element in a movement direction, and to determine the position of the second electronic device relative to the first electronic device, the at least one processor is further configured to cause the first electronic device to determine that the position of the second electronic device relative to the first electronic device is in the movement direction.

In some aspects, the techniques described herein relate to a first electronic device, to determine the position of the second electronic device relative to the first electronic device, the at least one processor is further configured to cause the first electronic device to automatically determine the position of the second electronic device relative to the first electronic device in response to the first electronic device being connected to the second electronic device and the multiple attempts to move the UI element from the display of the first electronic device to the display of the second electronic device.

In some aspects, the techniques described herein relate to a first electronic device, where the at least one processor is further configured to cause the first electronic device to: display a prompt for user input regarding whether to accept the determined the position of the second electronic device relative to the first electronic device; receive user input to the prompt; and provide the position of the second electronic device relative to the first electronic device in response to the user input to the prompt indicating to accept the determined the position of the second electronic device relative to the first electronic device.

In some aspects, the techniques described herein relate to a first electronic device, where the at least one processor is further configured to cause the first electronic device to display an indication of the position of the second electronic device relative to the first electronic device.

In some aspects, the techniques described herein relate to a first electronic device, where the at least one processor is further configured to cause the first electronic device to: check whether universal control for the first electronic device has been activated; and automatically detect the first position of the second electronic device relative to the first electronic device only if universal control for the first electronic device has been activated.

In some aspects, the techniques described herein relate to a first electronic device, where a user interface displayed on the first electronic device is different than a user interface displayed on the second electronic device, and the user interface displayed on the first electronic device is not displayed on the second electronic device.

In some aspects, the techniques described herein relate to a method, implemented in a first electronic device, the method including: detecting that the first electronic device is connected to a second electronic device; receiving user input that indicates multiple attempts to move a user interface (UI) element from a display of the first electronic device to a display of the second electronic device; determining, based at least in part on detecting that the first electronic device is connected to the second electronic device and the multiple attempts to move the UI element from the display of the first electronic device to the display of the second electronic device, a position of the second electronic device relative to the first electronic device; and providing, to an input control module, the position of the second electronic device relative to the first electronic device.

In some aspects, the techniques described herein relate to a method, where the multiple attempts include at least one unsuccessful attempt.

In some aspects, the techniques described herein relate to a method, where the multiple attempts include at least a threshold number of attempts within a threshold amount of time.

In some aspects, the techniques described herein relate to a method, further including receiving user input indicating at least one of the threshold number of attempts or the threshold amount of time.

In some aspects, the techniques described herein relate to a method, where the user input indicates movement of the UI element in a movement direction, and the determining includes determining the position of the second electronic device relative to the first electronic device is in the movement direction.

In some aspects, the techniques described herein relate to a method, where the determining includes automatically determining the position of the second electronic device relative to the first electronic device in response to detecting that the first electronic device is connected to the second electronic device and the multiple attempts to move the UI element from the display of the first electronic device to the display of the second electronic device.

In some aspects, the techniques described herein relate to a method, further including: displaying a prompt for user input regarding whether to accept the determined the position of the second electronic device relative to the first electronic device; receiving user input to the prompt; and providing the position of the second electronic device relative to the first electronic device in response to the user input to the prompt indicating to accept the determined the position of the second electronic device relative to the first electronic device.

In some aspects, the techniques described herein relate to a system, including: a first display; and a device position determination system configured to receive user input that indicates multiple attempts to move a user interface (UI) element from the first display to a second display of a second electronic device, determine, based at least in part on the multiple attempts to move the UI element from the first display to the second display, a position of the second electronic device relative to the first electronic device, output an indication of the position of the second electronic device relative to the first electronic device.

In some aspects, the techniques described herein relate to a system, where the multiple attempts include at least one unsuccessful attempt.

In some aspects, the techniques described herein relate to a system, where the user input indicates movement of the UI element in a movement direction, and the device position determination system is further configured to determine that the position of the second electronic device relative to the first electronic device is in the movement direction.

What is claimed is:

1. A first electronic device, comprising:
at least one memory; and
at least one processor coupled with the at least one memory and configured to cause first electronic device to:
detect that the first electronic device is connected to a second electronic device;
receive user input that indicates multiple attempts to move a user interface (UI) element from a display of the first electronic device to a display of the second electronic device;
determine, based at least in part on detecting that the first electronic device is connected to the second electronic device and the multiple attempts to move the UI element from the display of the first electronic device to the display of the second electronic device, a position of the second electronic device relative to the first electronic device; and
provide, to an input control module, the position of the second electronic device relative to the first electronic device.

2. The first electronic device of claim 1, wherein the multiple attempts include at least one unsuccessful attempt.

3. The first electronic device of claim 1, wherein the multiple attempts include at least a threshold number of attempts within a threshold amount of time.

4. The first electronic device of claim 3, wherein the at least one processor is further configured to cause the first electronic device to receive user input indicating at least one of the threshold number of attempts or the threshold amount of time.

5. The first electronic device of claim 1, wherein the user input indicates movement of the UI element in a movement direction, and to determine the position of the second electronic device relative to the first electronic device, the at least one processor is further configured to cause the first electronic device to determine that the position of the second electronic device relative to the first electronic device is in the movement direction.

6. The first electronic device of claim 1, to determine the position of the second electronic device relative to the first electronic device, the at least one processor is further configured to cause the first electronic device to automatically determine the position of the second electronic device relative to the first electronic device in response to the first electronic device being connected to the second electronic device and the multiple attempts to move the UI element from the display of the first electronic device to the display of the second electronic device.

7. The first electronic device of claim 1, wherein the at least one processor is further configured to cause the first electronic device to:
display a prompt for user input regarding whether to accept the determined the position of the second electronic device relative to the first electronic device;
receive user input to the prompt; and
provide the position of the second electronic device relative to the first electronic device in response to the user input to the prompt indicating to accept the determined the position of the second electronic device relative to the first electronic device.

8. The first electronic device of claim 1, wherein the at least one processor is further configured to cause the first electronic device to display an indication of the position of the second electronic device relative to the first electronic device.

9. The first electronic device of claim 1, wherein the at least one processor is further configured to cause the first electronic device to:
check whether universal control for the first electronic device has been activated; and
automatically detect the first position of the second electronic device relative to the first electronic device only if universal control for the first electronic device has been activated.

10. The first electronic device of claim 1, wherein a user interface displayed on the first electronic device is different than a user interface displayed on the second electronic device, and the user interface displayed on the first electronic device is not displayed on the second electronic device.

11. A method, implemented in a first electronic device, the method comprising:
detecting that the first electronic device is connected to a second electronic device;
receiving user input that indicates multiple attempts to move a user interface (UI) element from a display of the first electronic device to a display of the second electronic device;
determining, based at least in part on detecting that the first electronic device is connected to the second electronic device and the multiple attempts to move the UI element from the display of the first electronic device to the display of the second electronic device, a position of the second electronic device relative to the first electronic device; and
providing, to an input control module, the position of the second electronic device relative to the first electronic device.

12. The method of claim 11, wherein the multiple attempts include at least one unsuccessful attempt.

13. The method of claim 11, wherein the multiple attempts include at least a threshold number of attempts within a threshold amount of time.

14. The method of claim 13, further comprising receiving user input indicating at least one of the threshold number of attempts or the threshold amount of time.

15. The method of claim 11, wherein the user input indicates movement of the UI element in a movement direction, and the determining comprises determining the position of the second electronic device relative to the first electronic device is in the movement direction.

16. The method of claim 11, wherein the determining comprises automatically determining the position of the second electronic device relative to the first electronic device in response to detecting that the first electronic device is connected to the second electronic device and the multiple attempts to move the UI element from the display of the first electronic device to the display of the second electronic device.

17. The method of claim 11, further comprising:
displaying a prompt for user input regarding whether to accept the determined the position of the second electronic device relative to the first electronic device;
receiving user input to the prompt; and
providing the position of the second electronic device relative to the first electronic device in response to the user input to the prompt indicating to accept the determined the position of the second electronic device relative to the first electronic device.

18. A system, comprising:
a first display; and
a device position determination system configured to receive user input that indicates multiple attempts to move a user interface (UI) element from the first display to a second display of a second electronic device, determine, based at least in part on the multiple attempts to move the UI element from the first display to the second display, a position of the second electronic device relative to the first electronic device, output an indication of the position of the second electronic device relative to the first electronic device.

19. The system of claim 18, wherein the multiple attempts include at least one unsuccessful attempt.

20. The system of claim 18, wherein the user input indicates movement of the UI element in a movement direction, and the device position determination system is further configured to determine that the position of the second electronic device relative to the first electronic device is in the movement direction.
